(19) United States
(12) Patent Application Publication
(10) Pub. No.: US 2017/0294138 A1
(43) Pub. Date: Oct. 12, 2017

(54) Speech Improvement System and Method of Its Use

(71) Applicants: Patricia Kavanagh, Brooklyn, NY (US); Frederick E. Rowe, JR., Dallas, TX (US); Henry Ebbott-Burg, New York, NY (US); Colin Touhey, Brooklyn, NY (US)

(72) Inventors: Patricia Kavanagh, Brooklyn, NY (US); Frederick E. Rowe, JR., Dallas, TX (US); Henry Ebbott-Burg, New York, NY (US); Colin Touhey, Brooklyn, NY (US)

(21) Appl. No.: 15/482,649

(22) Filed: Apr. 7, 2017

Related U.S. Application Data
(60) Provisional application No. 62/319,955, filed on Apr. 8, 2016.

(51) Int. Cl. G09B 19/04; G08B 6/00; G09B 5/00; G08B 21/18

(52) U.S. Cl. CPC G09B 19/04; G08B 21/182; G08B 6/00; G09B 5/00

(57) ABSTRACT

A speech improvement system includes a memory, an audio input device, and a signal processing device. A baseline spoken audio signal is pre-recorded and stored in the memory. A real-time spoken audio signal is captured using the audio input device. The signal processing device is configured to compare the real-time spoken audio signal to the baseline spoken audio signal and generate a user alert, such as a haptic alert, an audible alert, and/or a visual alert, if the real-time spoken audio signal deviates from the baseline spoken audio signal by a preset threshold amount.

### CROSS-REFERENCE TO RELATED APPLICATIONS

This application claims the benefit of U.S. provisional application No. 62/319,955, filed 8 Apr. 2016, which is hereby incorporated by reference as though fully set forth herein.

### BACKGROUND

The instant disclosure relates to self-improvement. In particular, the instant disclosure relates to methods, systems, and applications for improvement of a user's speech.

Speech impediments occur in approximately 2.5% of the population. Numerous therapeutic strategies have been developed to address speech impediments, and many people improve in the clinic with such therapy. For purposes of quality of life, however, a person's everyday speech is perhaps an even better measure of success than in-clinic improvement. Yet, many speech therapy patients are unable to maintain in real-world settings the progress they make in therapy.

Even individuals without speech impediments often seek to improve their speaking skills in various settings, for example by taking classes on public speaking.

Software applications (“apps”) and associated hardware exist for a range of speech and language impediments. Extent apps and hardware, however, are directed at guided study in the context of speech therapy or speech training.

It would be desirable, therefore, to provide systems, applications, and methods for user-directed and real-time speech improvement.

### BRIEF SUMMARY

Disclosed herein is a method of improving speech, including: storing a baseline spoken audio signal from a user in a memory; receiving a real-time spoken audio signal from the user at a signal processing device connected to the memory; comparing the real-time spoken audio signal to the baseline spoken audio signal in the signal processing device; and generating a user alert if the real-time spoken audio signal deviates from the baseline spoken audio signal by a preset threshold amount.

In some embodiments of the disclosure, a plurality of domain-specific baseline spoken audio signals from the user can be stored in the memory, and a domain of the real-time spoken audio signal can be identified prior to comparing the real-time spoken audio signal to the baseline spoken audio signal, such that comparing the real-time spoken audio signal to the baseline spoken audio signal can include comparing the real-time spoken audio signal to a corresponding domain-specific signal of the plurality of domain-specific baseline spoken audio signals.

The step of comparing the real-time spoken audio signal to the baseline spoken audio signal in the signal processing device can include comparing at least one speech attribute of the real-time spoken audio signal to a corresponding at least one speech attribute of the baseline spoken audio signal. The at least one speech attribute can include one or more of volume, speed, cadence, enunciation, prosody, filler occurrence, and pronunciation accuracy. The step of comparing the real-time spoken audio signal to the baseline spoken audio signal in the signal processing device can also include comparing content of the real-time spoken audio signal to content of the baseline spoken audio signal.

The preset threshold amount can be user adjustable and/or domain-specific.

In embodiments, the user alert can persist until the real-time spoken audio signal returns to within the preset threshold amount of the baseline spoken audio signal.

The user alert can be one or more of haptic feedback delivered to the user through a wearable device, haptic feedback delivered to the user through a portable device, visual feedback, and/or audible feedback.

Also disclosed herein is a speech improvement system including: a memory configured to store a baseline spoken audio signal; an audio input device configured to capture a real-time spoken audio signal; a signal processing device operably coupled to the memory and the audio input device, wherein the signal processing device is configured to: compare the real-time spoken audio signal to the baseline spoken audio signal; and generate a user alert if the real-time spoken audio signal deviates from the baseline spoken audio signal by a preset threshold amount. The user alert can include haptic feedback delivered through a wearable device and/or through a portable device.

According to aspects of the disclosure, the memory, the audio input device, and the signal processor are integrated into a single unit, such as a smartphone, a tablet, a phablet, or another portable computing device.

The comparison of the real-time spoken audio signal to the baseline spoken audio signal can be domain-specific. It can also be based upon one or more of volume, speed, cadence, enunciation, prosody, filler occurrence, and pronunciation accuracy.

The foregoing and other aspects, features, details, utilities, and advantages of the present invention will be apparent from reading the following description and claims, and from reviewing the accompanying drawings.

### BRIEF DESCRIPTION OF THE DRAWINGS

FIG. 1 is a schematic depiction of a speech improvement system according to aspects of the instant disclosure.

FIG. 2 is a flowchart of representative steps that can be followed in a speech improvement method according to aspects of the instant disclosure.

### DETAILED DESCRIPTION

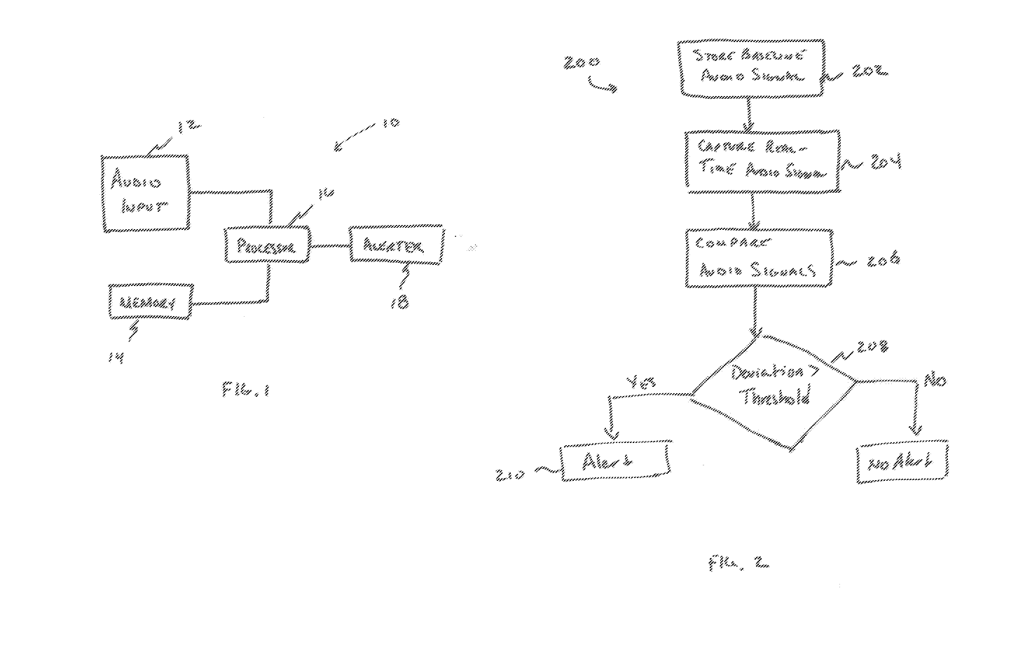

FIG. 1 schematically depicts a speech improvement system 10. Speech improvement system 10 generally includes an audio input device 12, a memory 14, a signal processing device 16, and an alerter 18.

According to aspects of the disclosure, audio input device 12, memory 14, signal processing device 16, and alerter 18 can all be integrated into a single unit, such as a portable computing device (e.g., a personal digital assistant, a smartphone, a phablet, a tablet, or the like). For example, a smartphone can include a microphone (audio input device 12), memory, one or more central processing units (signal processing device 16), and a haptic feedback generator, such as a vibratory motor (alerter 18).

In other aspects of the disclosure, one or more of audio input device 12, memory 14, signal processing device 16, and alerter 18 can be in separate units. For example, a lapel microphone (audio input device 12) can be in wireless communication (e.g., via Bluetooth, WiFi, or any other suitable protocol) with a smartphone, which can include both a memory and one or more central processing units (signal processing device 16). The smartphone can in turn be in wireless communication (e.g., via Bluetooth, WiFi, or another suitable protocol) with a wrist-worn device with a haptic feedback generator, such as a linear actuator (alerter 18).

FIG. 2 is a flowchart of representative steps 200 that can be followed to improve speech using speech improvement system 10 of FIG. 1. In block 202, a user's baseline spoken audio signal is stored in memory 14. The baseline spoken audio signal can, for example, be a recording of the user's best speech in a controlled environment (e.g., during a rehearsal of a presentation, during a speech therapy session, or the like).

It is also contemplated that a plurality of domain-specific baseline audio signals can be stored in memory 14. For example, the user can store a first baseline spoken audio signal from a business setting and a second baseline spoken audio signal from a social setting.

In block 204, a real-time spoken audio signal is captured (e.g., using audio input device 12). The real-time spoken audio signal is input to signal processing device 16 so that it can be compared to the baseline spoken audio signal in block 206.

Various attributes of the spoken audio signals can be compared in block 206. For example, in some embodiments, the volume of the real-time spoken audio signal is compared to the volume of the baseline spoken audio signal.

In other embodiments, the speed of the real-time spoken audio signal is compared to the speed of the baseline spoken audio signal.

In still other embodiments, the cadence of the real-time spoken audio signal is compared to the cadence of the baseline spoken audio signal.

In further embodiments, the prosody of the real-time spoken audio signal is compared to the prosody of the baseline spoken audio signal.

In yet additional embodiments, pronunciation in the real-time spoken audio signal is compared to pronunciation in the baseline spoken audio signal in order to assess the user's pronunciation accuracy.

In yet further embodiments, the presence of filler language (e.g., “uh,” “um,” and the like) in the real-time spoken audio signal is compared to the presence of filler language in the baseline spoken audio signal in order to assess the user's use of filler language.

It is also contemplated that the content of the real-time spoken audio signal can be compared to the content of the baseline spoken audio signal, in order to assess the user's content accuracy (e.g., to measure whether the user is giving the same speech that the user rehearsed and recorded as the baseline spoken audio signal).

If the comparison detects that the real-time spoken audio signal has deviated from the baseline spoken audio signal by more than a preset threshold amount (decision block 208), a user alert is generated in block 210.

The preset threshold can be dependent upon the particular attribute(s) of the audio signals being compared. For example, a user may allow greater deviations from the baseline spoken audio signal in terms of volume, but lesser deviations from the baseline spoken audio signal in terms of speed.

The preset threshold can also be user adjustable. For example, a user may initially allow greater deviations from the baseline spoken audio signal, and gradually tighten the allowable deviations over time as a progressive training measure.

The preset threshold can also be domain-specific. For example, a user may allow greater deviations from the baseline spoken audio signal in social settings than in business settings.

Various alerts are contemplated. For example, a visual signal (e.g., a flashing light) can appear on the user's portable device (e.g., smartphone or tablet) to alert the user to the deviation. In other embodiments, an audible signal (e.g., a warning tone) can be broadcast.

Haptic alerts, such as a vibration delivered through the user's portable device or a wearable device (e.g., a smartwatch) are also contemplated.

It is contemplated that the user can select which alert(s) the user wishes to receive in response to a deviation. It is also contemplated that the alerts can differ depending upon the nature of the deviation. For example, the frequency with which a flashing light blinks can increase as the deviation increases and reduce as the deviation reduces. As another example, the flashing light can be a different color, or the haptic feedback a different vibration pattern, depending on the attribute that is experiencing the deviation (e.g., a blinking red light for speed; a blinking green light for volume).

According to aspects of the disclosure, the alert can persist until the user corrects the real-time spoken audio signal to be within the preset threshold of the baseline spoken audio signal. Alternatively, the user can specify a time out period, after which the alert ceases even if the real-time spoken audio signal has not yet returned to within the preset threshold of the baseline spoken audio signal. It is also contemplated that the time out can reset if the real-time spoken audio signal later does return to within the preset threshold, and then once again deviates therefrom.

The teachings herein can be implemented, for example, in a software application, such as an application designed to run on a smartphone, tablet, or other computing device.

Although several embodiments of this invention have been described above with a certain degree of particularity, those skilled in the art could make numerous alterations to the disclosed embodiments without departing from the spirit or scope of this invention.

For example, the teachings herein can be applied to analyze the occurrence of filler language in a real-time spoken audio signal even without comparison to a pre-recorded baseline spoken audio signal.

All directional references (e.g., upper, lower, upward, downward, left, right, leftward, rightward, top, bottom, above, below, vertical, horizontal, clockwise, and counterclockwise) are only used for identification purposes to aid the reader's understanding of the present invention, and do not create limitations, particularly as to the position, orientation, or use of the invention. Joinder references (e.g., attached, coupled, connected, and the like) are to be construed broadly and may include intermediate members between a connection of elements and relative movement between elements. As such, joinder references do not necessarily infer that two elements are directly connected and in fixed relation to each other.

It is intended that all matter contained in the above description or shown in the accompanying drawings shall be interpreted as illustrative only and not limiting. Changes in detail or structure may be made without departing from the spirit of the invention as defined in the appended claims.

What is claimed is:

1. A method of improving speech, comprising:
storing a baseline spoken audio signal from a user in a memory;
receiving a real-time spoken audio signal from the user at a signal processing device connected to the memory;
comparing the real-time spoken audio signal to the baseline spoken audio signal in the signal processing device; and
generating a user alert if the real-time spoken audio signal deviates from the baseline spoken audio signal by a preset threshold amount.

2. The method according to claim 1, wherein storing a baseline spoken audio signal from a user in a memory comprises storing a plurality of domain-specific baseline spoken audio signals from the user in the memory.

3. The method according to claim 2, further comprising identifying a domain of the real-time spoken audio signal prior to comparing the real-time spoken audio signal to the baseline spoken audio signal, and wherein comparing the real-time spoken audio signal to the baseline spoken audio signal comprises comparing the real-time spoken audio signal to a corresponding domain-specific signal of the plurality of domain-specific baseline spoken audio signals.

4. The method according to claim 1, wherein comparing the real-time spoken audio signal to the baseline spoken audio signal in the signal processing device comprises comparing at least one speech attribute of the real-time spoken audio signal to a corresponding at least one speech attribute of the baseline spoken audio signal.

5. The method according to claim 4, wherein the at least one speech attribute comprises one or more of volume, speed, cadence, enunciation, prosody, filler occurrence, and pronunciation accuracy.

6. The method according to claim 1, wherein comparing the real-time spoken audio signal to the baseline spoken audio signal in the signal processing device comprises comparing content of the real-time spoken audio signal to content of the baseline spoken audio signal.

7. The method according to claim 1, wherein the preset threshold amount is user adjustable.

8. The method according to claim 1, wherein the preset threshold amount is domain-specific.

9. The method according to claim 1, wherein the user alert persists until the real-time spoken audio signal returns to within the preset threshold amount of the baseline spoken audio signal.

10. The method according to claim 1, wherein the user alert comprises haptic feedback delivered to the user through a wearable device.

11. The method according to claim 1, wherein the user alert comprises haptic feedback delivered to the user through a portable device.

12. The method according to claim 1, wherein the user alert comprises visual feedback.

13. The method according to claim 1, wherein the user alert comprises audible feedback.

14. A speech improvement system, comprising:
a memory configured to store a baseline spoken audio signal;
an audio input device configured to capture a real-time spoken audio signal;
a signal processing device operably coupled to the memory and the audio input device, wherein the signal processing device is configured to:
compare the real-time spoken audio signal to the baseline spoken audio signal; and
generate a user alert if the real-time spoken audio signal deviates from the baseline spoken audio signal by a preset threshold amount.

15. The system according to claim 14, wherein the user alert comprises haptic feedback delivered through a wearable device.

16. The system according to claim 14, wherein the user alert comprises haptic feedback delivered through a portable device.

17. The system according to claim 14, wherein the memory, the audio input device, and the signal processor are integrated into a single unit.

18. The system according to claim 17, wherein the single unit comprises a portable computing device.

19. The system according to claim 14, wherein the comparison of the real-time spoken audio signal to the baseline spoken audio signal is domain-specific.

20. The system according to claim 14, wherein the comparison of the real-time spoken audio signal to the baseline spoken audio signal is based upon one or more of volume, speed, cadence, enunciation, prosody, filler occurrence, and pronunciation accuracy.
